(19) United States
(12) Patent Application Publication
(10) Pub. No.: US 2005/0072037 A1
(43) Pub. Date: Apr. 7, 2005

(54) Fishing poles, counter-balancing apparatus for fishing poles and handles, and methods for balancing fishing poles

(76) Inventors: Duane C. Markley, Veradale, WA (US); Ron Stokes, Veradale, WA (US)

Correspondence Address: WELLS ST. JOHN P.S., 601 W. FIRST AVENUE, SUITE 1300, SPOKANE, WA, 99201, US

(21) Appl. No.: 10/679,224

(22) Filed: Oct. 2, 2003

(51) Int. Cl. A01K 87/00

(52) U.S. Cl. 43/23

(57) ABSTRACT

A counter-balancing apparatus for a fishing pole handle is provided. The apparatus includes one or more weight members configured to be received by a handle assembly of the fishing pole. The handle assembly includes at least one handle portion, wherein the handle portion is configured to removably receive the one or more weight members to cause a transfer of a center-of-mass of the fishing pole between different positions. The one or more weight members and the handle portion may have equal radii so that, upon assembly, the one or more weight members appear to be integrally formed with the handle portion. Other configurations are possible. A method is also provided.

### TECHNICAL FIELD

The present invention pertains to fishing poles and fishing handles. More particularly, aspects of the invention relate to apparatuses and methods for balancing handles, and fishing pole handles.

### BACKGROUND OF THE INVENTION

A typical fishing pole has a handle, a rod, and a plurality of line guides spaced apart along the rod. Typically, the rod is a straight rod. A reel seat is provided on the handle for supporting a fishing reel. Line from the reel is guided along the rod via the line guides that are axially aligned along the rod. Line leaves the rod at a distal end via a line guide provided on a tip end of the rod. In many cases, the rod includes a plurality of segments that are joined together with ferrules to enable breakdown and storage of the fishing pole. However, these rods are typically 6, 7, 8 or even 9 feet long which means they are not compact, even when broken down and stowed. Further, recent trend indicates a shift towards manufacturing fishing poles with short and stubby rods.

Several attempts have been made to provide a compact fishing pole. U.S. Pat. Nos. 2,541,759; 2,559,934; 2,610,427; 3,216,144; 4,027,419; and 5,444,934 disclose various fishing poles with short rods that attempt to provide benefits of longer rods through various structural features.

Some of the benefits of longer fishing rods include the ability to fluidly cast a fishing reel, and increased casting distance when compared to fishing poles having short and stubby rods. Further, longer length of the fishing rods provides for easier upstream mending while enabling better control of the swing of the fly.

In order for fishing poles having short and stubby rods to mimic the benefits inherent of the longer rods, such as, for example, achieving fluid-casting strokes and increased casting distance, fishing poles having shorter rods may have to be appropriately balanced. Additionally, traditional (and longer) fishing poles have also been designed to have a desired balance. For example, fly rods have a designed-in stiffness and weight distribution. Users often select a rod based on these characteristics.

Prior approaches include custom designing fishing poles to the needs of a user to achieve fluid casting strokes and better control of the swing of the line and hook. However, such custom designed approaches are costly and it can be impractical to custom tailor the balancing of a fishing pole for each specific application.

In an unrelated area, several attempts have been made to balance golf clubs by adding counter-balancing weights to the golf clubs. For example, U.S. Pat. Nos. 4,607,846; 5,261,669; 5,013,041; 5,683,309; 6,210,290 B1; 6,306,048 B1; 6,379,263 B2 disclose various approaches for counter-balancing golf clubs. However, counter-balancing of fishing poles having short and stubby rods to achieve user-desired feel and swing has not been attempted.

Accordingly, improvements are needed to eliminate the above-described deficiencies.

### SUMMARY OF THE INVENTION

A fishing pole is provided having a handle assembly and a rod carried by the handle assembly. The handle assembly includes one or more weights that are removably mounted thereon in order to shift a center-of-mass of the fishing pole. Furthermore, several configurations are provided in order to achieve reliable balancing of the fishing pole by removably mounting one or more weights to the handle, in accordance with user desires. In one case, at least one portion of the handle assembly is configured to pivot with respect to another portion of the handle assembly. In other cases, the handle assembly is formed as an integral member configured to receive a fishing rod via a connector assembly.

According to one aspect, a fishing pole including a handle assembly, and a rod carried by the handle assembly is provided. The handle assembly includes one or more weights configured to be removably mounted to the handle assembly to shift a center-of-mass of the fishing pole.

According to another aspect, a counter-balancing apparatus for a fishing pole handle is provided. The apparatus includes one or more weight members configured to be received by a handle assembly of the fishing pole. The handle assembly includes at least one handle portion, wherein the handle portion is configured to removably receive the one or more weight members to cause a transfer of a center-of-mass of the fishing pole between different positions. The one or more weight members and the handle portion have equal radii so that, upon assembly, the one or more weight members appear to be integrally formed with the handle portion.

According to yet another aspect, an apparatus for counter-balancing a handle is provided. The apparatus includes one or more balancing weight members configured to be removably supported by a handle of the fishing pole. The one or more balancing weight members are configured to produce a counter-balancing weight on the handle by relocating a centroid of the handle between different positions.

According to a further aspect, a method for balancing a fishing pole is provided. The method includes removably mounting one or more balancing weights to a handle of a fishing pole, and relocating a center-of-mass of the fishing pole between different locations by selectively mounting the balancing weights to the handle, thereby producing a counter-balancing weight on the fishing pole.

According to yet another aspect, a handle for a fishing pole is described. The handle includes a structural member for supporting a fishing reel, and at least one mass carried by the structural member for custom tailoring balance of the handle.

### BRIEF DESCRIPTION OF THE DRAWINGS

Preferred embodiments of the invention are described below with reference to the following accompanying drawings.

FIG. 1 is a perspective view of a fishing pole having a handle assembly, a fishing rod and connector assembly, wherein the handle assembly is mounted with balancing weights, according to one aspect of the present invention.

FIG. 2 is a partially disassembled and exploded perspective view of the handle assembly shown in FIG. 1, the partially disassembled view showing counter-balancing weights prior to their mounting on the handle assembly, in accordance with an embodiment of the present invention.

FIG. 3 is an assembled side view of a handle assembly of a fishing pole in accordance with another embodiment of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

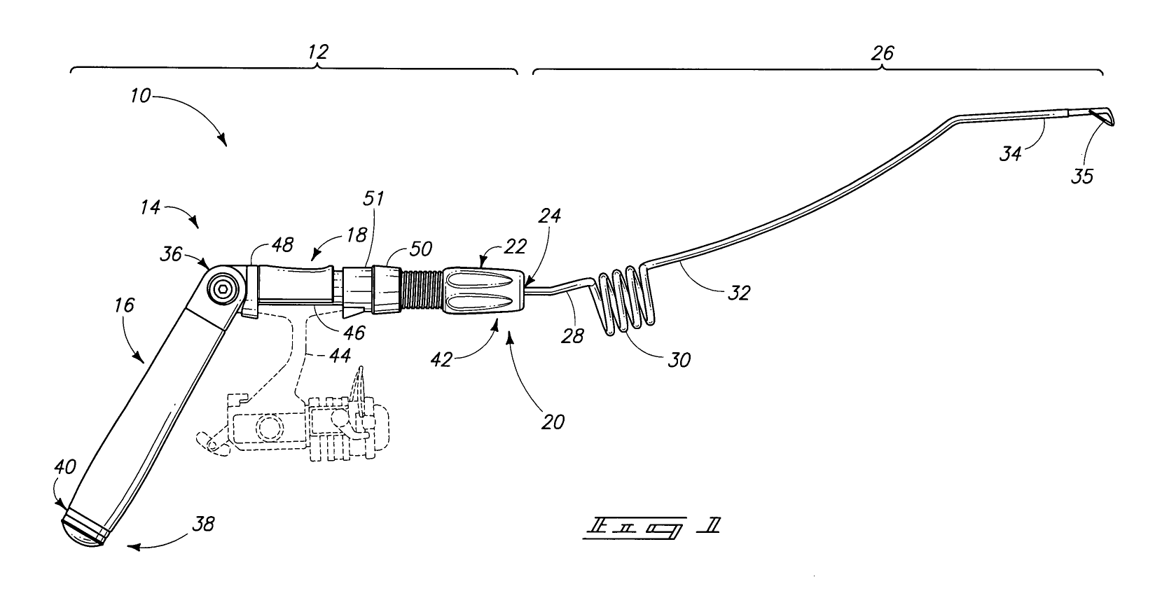

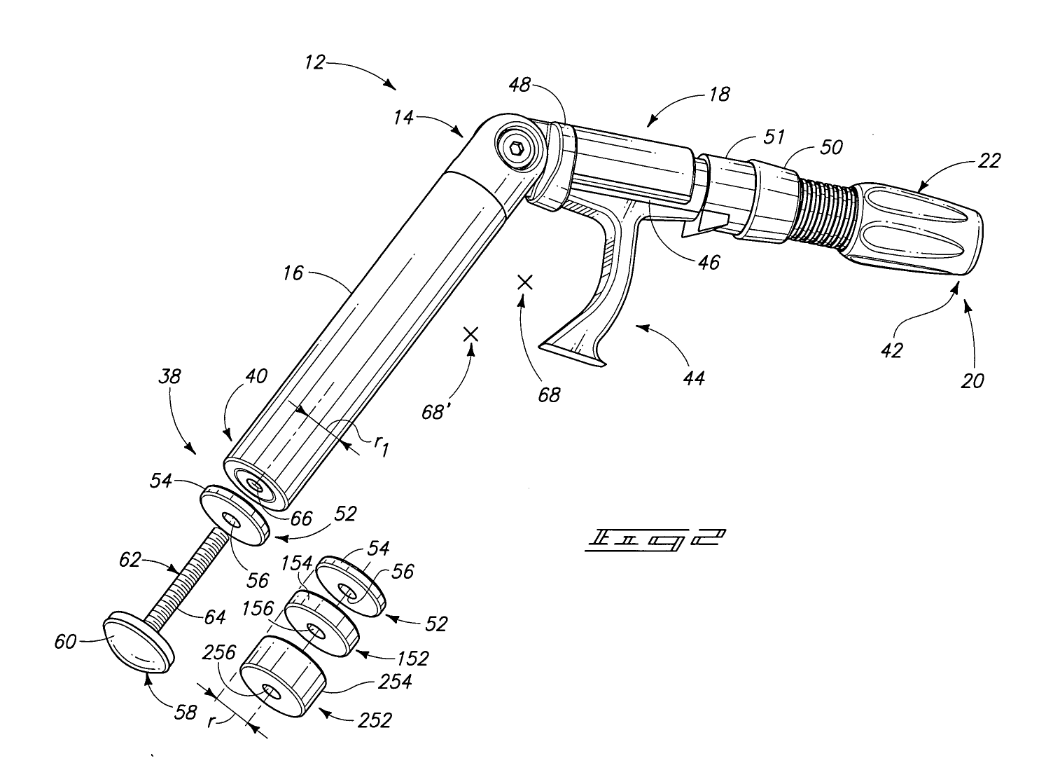

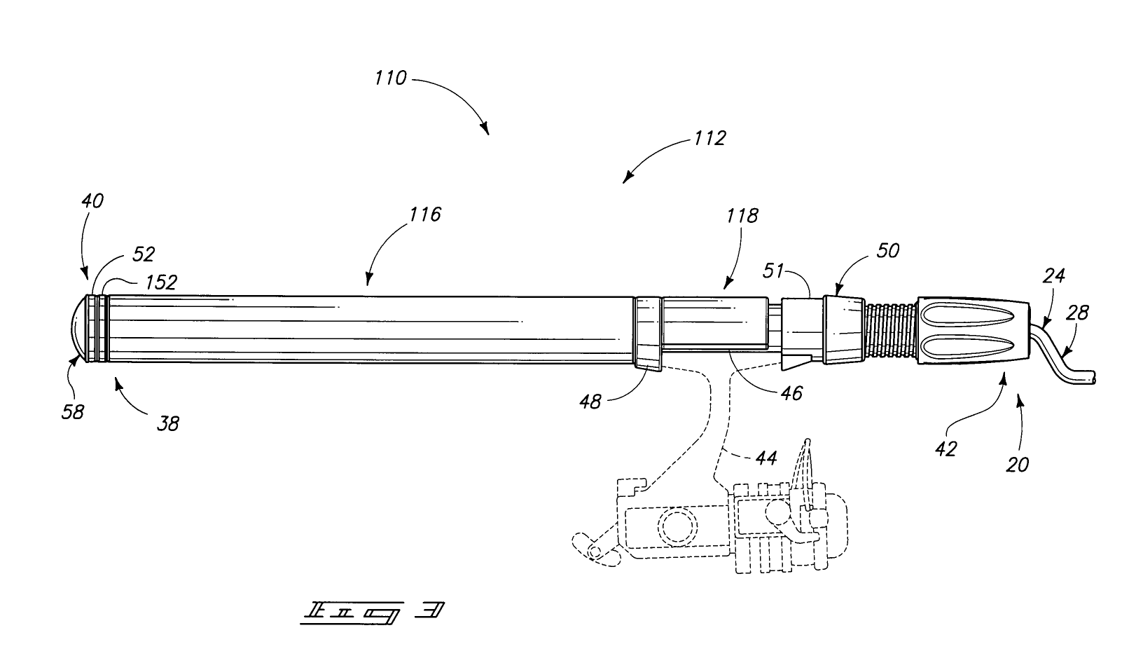

Reference will now be made to preferred embodiments of Applicants' invention. Two exemplary implementations are described below and depicted with reference to the drawings comprising fishing poles, handle assemblies, handles, and counter-balancing weights to balance fishing pole handles by shifting a center-of-mass, or centroid, or center-of-gravity of a fishing pole between different positions, according to various aspects of the present invention. A first embodiment is shown and described below in a first configuration with reference generally to FIGS. 1-2, and a second embodiment is shown and described below with reference to FIG. 3.

While the invention is described by way of various preferred embodiments, it is understood that the description is not intended to limit the invention to these embodiments, but is intended to cover alternatives, equivalents, and modifications which may be broader than these embodiments such as are defined within the scope of the appended claims.

Furthermore, in an effort to prevent obscuring the invention at hand, only details germane to implementing the invention will be described in great detail, with presently understood peripheral details being incorporated by reference, as needed, as being presently understood in the art.

A preferred embodiment fishing pole in accordance with the invention is first described with reference to FIGS. 1-2 and is identified by reference numeral 10. Fishing pole 10 includes a handle assembly 12 that supports a rod 26. According to one construction, rod 26 is removably supported for mating and demating with handle assembly 12 using a connector assembly 20. In another construction, rod 26 may be fixedly connected to handle assembly 12. Further details of supporting rod 26 by handle assembly 12 are set forth in co-pending applications having Ser. No. 10/607,285 entitled “Fishing Rod” and Ser. No. 10/655,792 entitled “Fishing Rod Connector, and Connector Assemblies for Fishing Poles”, the entire contents of both the applications are incorporated herein by reference.

Fishing pole 10 removably supports a fishing reel 44 onto which a fishing line is spooled for removal and retrieval when casting and retrieving a fishing hook (not shown). Fishing reel 44 is removably attached to reel seat 46 provided on the handle assembly 12.

As shown in FIG. 1, handle assembly 12 includes a handle 14. Handle 14 includes a lower handle portion 16 and an upper handle portion 18. In one construction, lower handle portion 16 is attached to upper handle portion 18 using an articulating hinge 36. In such construction, lower handle portion 16 pivots about hinge 36 to achieve varied casting angles as desired by a user. Handle assembly 12 includes a proximal end 40 and a distal end 42. An adjustable weighting assembly 38 is removably mounted or attached to handle assembly 12. In one construction, weighting assembly 38 is removably mounted to lower handle portion 16 of handle assembly 12. Although such is shown to be exemplary, weighting assembly 38 may be removably mounted to other portions of handle assembly 12 depending on various other configurations of fishing poles.

Continuing to refer to FIG. 1, it shows weighting assembly 38 in its assembled form and as mounted to handle assembly 12. Adjustable weighting assembly 38 is alternatively referred to herein as weight assembly, or weights, or weight members, or counter-balancing weights, or counter-balancing weight members in reference to various aspects of the invention. Further details of weighting assembly 38 are set forth and described with reference to FIG. 2 as described below.

Upper handle portion 18 is configured to support connector assembly 20 that is disposed adjacent distal end 42 of handle assembly 12. Upper handle portion 18 includes a retaining collar 48, and a threaded locking ring (or nut) 50 and a retaining collar 51. Spinning reel 44, attached to reel seat 46, is removably supported by upper handle portion 18 of handle assembly 12. Connector assembly 20 includes a female connector member 22 and a male connector member 24 that is provided on rod 26. Each retaining collar 48, 51 includes a local, outward detent that receives a respective end of a reel seat member of a reel 44.

As shown in FIG. 1, handle assembly 12 includes spinning reel 44 is provided along a bottom surface of handle portion 18 of handle assembly 12. In other constructions, the reel seat 46 may be provided along an upper surface of handle portion 18. The threaded locking ring 50 provided on handle portion 18 mates with complementary threads on handle assembly 12 to move ring 50 and retaining collar 51 forward and aft along handle assembly 12 to entrap reel 44 under reel seat 46 via collars 48 and 51. Such a construction of a reel seat 46 is configured for mounting casting reel 44 under handle assembly 12 and is well understood in the art. Alternatively, as noted above, varying other types of reels can be incorporated for mounting onto a reel seat 46 of handle assembly 12 for casting, bait casting, or trolling.

As shown in FIG. 1, fishing rod 26 includes a base portion 28 which supports a coil spring 30 having a local mass. Although a single coil spring 30 is shown herein, fishing rod 26 may be provided with more than one coil spring. Further details and various possible constructions of coil springs are set forth in the above-referenced co-pending applications, the entire contents of which have been incorporated by reference in this application. Fishing rod 26 includes a bowed portion 32 that terminates at a tip 34. Tip 34 also includes a line guide 35 at a distal end located away from coil spring 30.

As shown in FIG. 1, bowed portion 32 of rod 26 diverges from base portion 28 at a distal end near tip 34. In order to achieve such a divergence, bowed portion 32 deviates from axial alignment in an upward direction away from a direction of bend that would be imparted by fishing line tension being applied to rod 26 while landing a fish. In essence, rod 26 comprises an arcuate section that is shaped upwardly and away from a direction of loading when retrieving a fish. Because of load encountered during retrieving of fish, balancing of handle assembly 12 is needed to counterbalance load encountered during retrieval of fish by shifting center-of-mass of handle assembly 12. Exemplary factors in support of the need to counter-balance a fishing pole handle have been set forth above.

Fishing pole 10 shown in FIG. 1 may be reconfigured to a fishing pole suitable for steelhead fishing where it is preferred to have a top-mounted spinning reel rather than a bottom-mounted spinning reel. In order to achieve such, handle portion 16 may be rotated by about 90 degrees from the position in FIG. 1. Subsequently, handle assembly 12 may be rotated by about 180 degrees such that spinning reel 44 is reconfigured as a top-reel mount on reel seat 46. However, a new rod (not shown) is then attached to handle assembly 12, having line guides along a top edge. In the new configuration, reel seat 46 is located along a top surface of handle portion 18 of handle assembly 12.

FIG. 2 shows a partially disassembled and exploded perspective view of handle assembly 12 in accordance with one embodiment of the present invention. A plurality of weight members 52, 152, and 252 configured to be removably mounted on the handle assembly 12 are also shown in FIG. 2. The partially disassembled view of handle assembly 12 shows weighting assembly 38 comprising a counter-balancing weight 52 prior to its mounting on handle assembly 12. Weighting assembly 38 may include just a member 58 (which has mass), or one or more weights 52, 152, and 252 received by member 58. The illustrated weights are merely exemplary. It will be appreciated that weighting assembly 38 may include more or less number of weights than those that have been illustrated in FIG. 2. In one exemplary construction as shown in FIG. 2, weighting assembly 38 is configured to be removably mounted to lower handle portion 16. Weighting assembly 38 may be mounted in different portions of handle assembly 12 in various other possible constructions.

In the exemplary construction as shown in FIG. 2, member 58 of weighting assembly 38 is configured as a fastener having a head 60 and a shank 62 including a male threaded portion 64. Threaded portion 64 is configured to be engaged with complementary female threaded grooves 66 provided in an end portion 40 of lower handle portion 16 of handle assembly 12. Handle assembly 12 may be supplied in an assembled state with member 58. A center-of-mass of such supplied handle assembly 12 may be located at a position 68 due to inherent weight of member 58 in addition to inherent weights of handle assembly 12 and the fishing rod 26 (FIG. 1).

Individual weights 52, 152, and 252 may be configured in different sizes (e.g., small or large), shapes (e.g., rectangular, spherical, circular, or any other shape), and weights. Weights 52, 152, 252 respectively comprise a disk 54, 154, 254, and a bore 56, 156, 256. Respective bores 56, 156, and 256 may be cylindrical. Further, individual weights 52, 152, and 252 may be configured to have a cross-sectional surface profile so as to match a cross-sectional surface profile of a portion of handle assembly 12 wherein such weights are removably mounted. For example, in the illustrated embodiment of FIG. 2, where individual weights 52, 152, and 252 are configured to be removably mounted to lower handle portion 16, in order to match the surface profiles of lower handle portion 16 and respective individual weights 52, 152, and 252, such weights are configured to have a radius “r” that is substantially equal to a radius “r1” of lower handle portion 16. In one embodiment, each of the weights 52, 152, and 252 are configured to have equal radii.

Mounting of weight 52 to handle assembly 12 includes receiving such weight by member 58 and assembling member 58 in threaded engagement with proximal end 40 of handle assembly 12. More specifically, shank 62 of member 58 receives weight 52 by way of insertion via bore 56. Member 58 with weight 52 mounted thereon, and having male threaded portion 64 of shank 62, is fixed in threaded engagement in a recess having complementary female threaded grooves 66 near proximal end 40 of lower handle portion 16 of handle assembly 12. Upon mounting, weighting assembly 38 is engaged to lower handle portion 16 in a flush manner and appears to be an integral part of the handle assembly.

In one exemplary case, surface profiles of disks 54, 154, and 254, respectively, of weights 52, 152, and 252 may be configured to match a surface profile, at proximal end 40 of lower handle portion 16. Matching of such surface profiles enables individual weights (e.g., 52, 152, 252) to be mounted flush to handle portion 16 such that, upon assembly, such weights appear to be an integral part of handle portion 16 of the handle assembly 12 supporting or receiving such weights. For example, if a handle portion is configured to have a D-shaped cross-sectional profile, weight members may also be configured to have a corresponding D-shaped cross-sectional profile such that, upon assembly, the handle portion and the weight members appear to be formed from an integral member.

It will be appreciated that although it is preferred to have matching contour surfaces of the handle assembly and the weight members, it is not necessary that such is required. Surface profiles of the handle assembly (e.g., handle assembly 12) and the weight members (e.g., weights 52, 152, and 252) may be configured to be distinct.

Accordingly, as noted above, in another exemplary case, cross-sectional surface profile of individual weights 52, 152, and 252 may be configured to be different from cross-sectional surface profile of a portion (e.g., handle portion 16) of handle assembly. For example, individual weights 52, 152, and 252 may be configured to have a radius “r” that is greater than radius “r1” of handle portion 16. Such a configuration may enable to provide additional support to a user during fishing by preventing accidental slipping of handle assembly 12 from a user's hand.

Further, support may be provided to a user by coating the handle assembly 12 and individual weights 52, 152, and 252 with various materials configured to provide gripping support and prevent slipping of the handle assembly 12 during fishing. Such materials may include, for example, cork, rubber, or provision of a knurled surface. Individual weights 52, 152, and 252 may be color coated with distinct colors to readily identify their respective weights to a user.

It will be appreciated that counter-balancing weights to balance fishing pole handles may be mounted to fishing pole handles in different other ways than what has been mentioned above. For example, a handle portion (e.g., handle portion 18) of handle assembly 12 may be configured to be hollow, and one or more counter-balancing weights may be inserted into the hollow portion of the handle assembly. The handle portion may be provided with an end cap to prevent the counter-balancing weights from slipping out the hollow handle portion. The handle portion may be configured to be hollow at locations, within the handle portion, configured to receive the counter-balancing weights.

The counter-balancing weights may comprise metal members (e.g., spheres, rectangular blocks, or other shaped members), metal members with reinforced plastic, weighted disk(s), putty, etc. The weights can also be attached at other locations along a handle assembly.

Weight 52 may be removably mounted to handle assembly in order to shift the center-of-mass of handle assembly 12 from a position indicated by reference numeral 68 to a different position indicated by reference numeral 68′. Other weights 152 and 252 may be similarly removably mounted to handle assembly as desired by a user.

In the event a user desires to shift the center-of-mass of the handle assembly 12 (as well as the entire fishing pole 10) to a position other than the position indicated by reference numeral 68′, a different weight member (e.g., 152 or 252) configured with a different size and weight may be mounted to the handle assembly 12. Such mounting may be performed either by adding such different weight member (e.g., 152 or 252) to weighting assembly 38 and weight member 52, or by removing weight member 52 and mounting the different weight member (e.g., 152 or 252) its place. Addition of a different weight member causes the center-of-mass of the handle assembly to shift from its original position 68 to a further different user desired position that is different from position 68′. Addition of weights and causing a shift in center-of-mass may be performed to provide a counter-balance to fishing pole handles and fishing poles in order to achieve a desired swing and fluidity in casting strokes. Thus, the present invention enables a user to quickly, efficiently, and in a cost-effective manner customize a fishing pole handle (and entire fishing pole) to adjust the feel and casting fluidity in accordance with the desires of the user.

FIG. 3 illustrates an assembled side view of handle assembly 112 of fishing pole 110 in accordance with another embodiment of the present invention, wherein elements like those shown in FIG. 2 are illustrated using like reference numerals, but with a prefix “1” added. But for the differences disclosed herein, the rest of the features depicted in FIG. 3 are similar to what has been described above with regard to the embodiment of FIG. 2.

In the embodiment shown in FIG. 3, handle portions 116 and 118 of handle assembly 112 are integrally formed instead of forming them as two distinct handle portions that are configured to pivot about a hinge as shown earlier in FIG. 2. Thus, in the embodiment shown in FIG. 3, handle portions 116 and 118 lie on the same plane. The methodology for mounting or supporting weights 152, 1152 at a proximal end 140 of handle assembly 112 is similar to the methodology that has been described earlier with reference to FIG. 2, and therefore will not be repeated. Further, similar to what has been described at FIG. 2, one or more weights (e.g., 152, 1152) may be removably mounted to the handle assembly 112 in order to counter-balance weight of the handle assembly 112 by causing a shift of the center-of-mass of the handle assembly 112 between various positions.

Accordingly, the previous embodiments depict various fishing poles that present the action of a relatively long pole, such as a six or seven-foot long fishing pole, in the package size of a two to four-foot long fishing pole with the added convenience of easily attaching and removing weights to handle assembly according to user desires. Individual ones of a plurality of handles having counter-balancing weighting assemblies may be removably coupled to a fishing rod, further fulfilling the desires of a user wishing to use a specific handle with different rods. Furthermore, traditional long fishing poles (and handles) can also be balanced using the present apparatus and methods.

A further alternative construction uses the combination of a longer (or shorter) second handle portion in combination with one or more weight members to relocate a centroid of the handle (and pole).

Thus, because of the relative ease of counter-balancing weight of a fishing pole and fishing pole handles, a user is provided with an ability to quickly and easily balance a fishing pole handle in order to achieve a desired feel and casting fluidity. Aspects of the invention enable weight of a fishing pole handle in particular, or a fishing pole in general, to be changed while fishing by removing one or more weights from the handle assembly and replacing the removed weights with a different set of weights. The weight of the fishing pole handle and the fishing pole may therefore be customized for different conditions in accordance with user desires and for a specific rod which has been selected for the current application or use.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A fishing pole comprising:
a handle assembly; and
a rod carried by the handle assembly, wherein
the handle assembly includes one or more weights configured to be removably mounted to the handle assembly to shift a center-of-mass of the fishing pole.

2. The fishing pole of claim 1, wherein the one or more weights are removably attached to the fishing pole to shift the center-of-mass of the fishing pole between different positions in order to customize counter-balance of the fishing pole according to user preferences.

3. The fishing pole of claim 1, wherein the handle assembly comprises:
a first handle portion; and
a second handle portion removably attached to the first handle portion.

4. The fishing pole of claim 3, wherein the second handle portion has a selected length for tailoring centroid of the fishing pole.

5. The fishing pole of claim 3, wherein the second handle portion is configured to pivot about a point where the second handle portion attaches to the first handle portion.

6. The fishing pole of claim 3, wherein the first and second handle portions are integrally formed.

7. The fishing pole of claim 3, wherein the second handle portion comprises a longitudinal member having proximal and distal end portions, and wherein the proximal end portion is located adjacent the first handle portion and the distal end portion is located away from the first handle portion.

8. The fishing pole of claim 7, wherein the one or more weights are provided adjacent the distal end portion of the second handle portion.

9. The fishing pole of claim 5, wherein the distal end portion comprises female engagement grooves configured to receive complementary male engagement grooves provided on an end member configured to receive the one or more weights.

10. The fishing pole of claim 9, wherein the one or more weights comprise a cylindrical bore.

11. The fishing pole of claim 9, wherein the one or more weights comprise substantially equal radius.

12. The fishing pole of claim 9, wherein the one or more weights and the second handle portion have substantially equal radii, wherein upon assembly, the one or more weights and the second handle portion appear to be integrally formed.

13. The fishing pole of claim 9, wherein the end member comprises a screw arranged in threaded engagement with a recess provided in the distal end of the second handle portion to attach the one or more weights carried by the end member to the handle assembly.

14. The fishing pole of claim 9, wherein the insertion member comprises:
a head;
a shank having first and second ends, wherein the first end is attached to the head, and the second end includes the complementary male engagement grooves configured to be received by the female engagement grooves in the distal end portion of the second handle portion.

15. The fishing pole of claim 14, wherein the shank is configured to receive the one or more weights via the cylindrical bore of the respective one or more weights.

16. The fishing pole of claim 1, wherein a cross-sectional contour of the one or more weight members follows substantially a cross-sectional contour of the handle assembly configured to receive the weight members.

17. The fishing pole of claim 1, wherein the one or more weights comprise metal, metal with reinforced plastic, magnets.

18. A counter-balancing apparatus for a fishing pole handle, comprising:
one or more weight members configured to be received by a handle assembly of the fishing pole, the handle assembly including at least one handle portion;
wherein the at least one handle portion is configured to removably receive the one or more weight members to cause a transfer of a center-of-gravity of the fishing pole between different positions, and
wherein the one or more weight members and the at least one handle portion have substantially equal radii so that, upon assembly, the one or more weight members appear to be integrally formed with the at least one handle portion.

19. The apparatus of claim 18, wherein the handle assembly comprises:
a first handle portion; and
a second handle portion located adjacent the first handle portion.

20. The apparatus of claim 19, wherein the first handle portion is configured to support a fishing rod and the second handle portion is configured to support the one or more weight members.

21. The apparatus of claim 19, wherein the second handle portion pivots about a point of attachment of the second handle portion to the first handle portion.

22. The apparatus of claim 19, wherein the first and second handle portions are integrally formed and lie on a common plane.

23. The apparatus of claim 18, wherein the one or more weight members have substantially equal radii.

24. The apparatus of claim 18, wherein the one or more weight members have a surface contour that is substantially similar to a surface contour of the at least one handle portion.

25. The apparatus of claim 24, wherein the one or more weight members and the at least one handle portion have substantially equal radii.

26. An apparatus for counter-balancing a handle, comprising:
one or more balancing weight members configured to be removably supported by a handle of the fishing pole; and
wherein the one or more balancing weight members are configured to produce a counter-balancing weight on the handle by relocating a centroid of the handle between different positions.

27. The apparatus of claim 26, wherein the handle comprises:
first and second handle portions configured to support a fishing rod and the one or more balancing weight members, respectively.

28. The apparatus of claim 27, wherein the first and second handle portions pivot about a point of attachment of the first handle portion to the second handle portion.

29. The apparatus of claim 27, wherein the first and second handle portions are integrally formed.

30. The apparatus of claim 26, wherein the one or more balancing weight members have substantially equal diameter and distinct mass.

31. The apparatus of claim 26, wherein the one or more balancing weight members have a surface contour that is substantially similar to a surface contour of the handle.

32. The apparatus of claim 31, wherein the one or more balancing weight members and the handle have substantially equal radii.

33. The apparatus of claim 31, wherein the one or more balancing weight members and the handle have substantially equal radii to render the balancing weight members to appear as being integrally formed upon assembly of the weight members to the handle.

34-42. (Cancelled)

43. A handle for a fishing pole, comprising:
a structural member for supporting a fishing reel; and
at least one mass carried by the structural member for custom tailoring balance of the handle.
